(19) United States
(12) Patent Application Publication
(10) Pub. No.: US 2006/0036664 A1
(43) Pub. Date: Feb. 16, 2006

(54) Efficient FIR filter suitable for use with high order modulation radio frequency transmitters

(75) Inventors: Thomas J. Kenney, San Diego, CA (US); James R. Robertson, San Diego, CA (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/917,784

(22) Filed: Aug. 13, 2004

(51) Int. Cl. G06F 17/10

(52) U.S. Cl. 708/300

(57) ABSTRACT

A linear filter includes an input node to receive an X-bit digital representation of a signal to be filtered; an output node to output a B-bit digital representation of a filtered output signal; an N-bit delay line having an input coupled to the input node and N outputs; and a lookup table stored in a storage device having N address inputs coupled to the N outputs of the delay line and B output bits coupled to the output node. The lookup table represents a mapping between individual ones of the X-bit digital representations of the input signal and a corresponding linearly filtered output signal. A ROM-based FIR filter for a transmitter of a cellular telephone is one non-limiting embodiment of this invention.

### TECHNICAL FIELD

The preferred embodiments of this invention relate generally to radio frequency (RF) transmitter circuitry and, more specifically, relate to finite impulse response (FIR) filters that form a part of an RF transmitter.

### BACKGROUND

In the majority of wireless communication systems the pulse shape filtering of the data stream is performed prior to the signal being frequency translated, amplified and transmitted. Depending on the type of wireless system, the design criteria for the pulse shape filter can vary from bandwidth containment to bandwidth expansion (in the case of Nyquist pulses) in order to minimize inter-symbol interference (ISI). Regardless of the design criteria, filtering is required as part of the overall transmitter design.

It is typically desirable to provide pulse shape filters that are linear and, as a result, linear transversal filters (FIR filters) are widely used. However, a drawback of FIR filter structures as opposed to infinite impulse response (IIR) structures is that the FIR filters require many more taps to attain the same desired frequency response. Additionally, since the filter dictates the bandwidth and response of the overall signal, the numerical accuracy of the filtering process is critical. Conventional FIR filters typically use multipliers and adders with reasonably large bit-widths. When considering complex modulated waveforms, where two filters are needed (one for the in-phase and one for the quadrature-phase), the total filtering operation can require a significant amount of silicon size and therefore cost. Traditionally, the FIR filter is implemented using multipliers and adders with bit-widths dictated by the acceptable distortion allowed in the filters output signal.

Additionally, with the inclusion of high order modulated (HOM) waveforms (e.g., eight level Phase Shift Keying (8-PSK) and 16 level Quadrature Amplitude Modulation (16-QAM) waveforms), even larger bit-widths are required in order for the internal operations of the FIR filter to represent the additional dynamics in the modulated signal.

### SUMMARY OF THE PREFERRED EMBODIMENTS

The foregoing and other problems are overcome, and other advantages are realized, in accordance with the presently preferred embodiments of this invention.

A linear filter is disclosed to include an input node to receive an X-bit digital representation of a signal to be filtered; an output node to output a B-bit digital representation of a filtered output signal; an N-bit delay line having an input coupled to the input node and N outputs; and a lookup table stored in a storage device having N address inputs coupled to the N outputs of the delay line and B output bits coupled to the output node. The lookup table represents a mapping between individual ones of the X-bit digital representations of the input signal and a corresponding linearly filtered output signal.

A method is also disclosed to filter a signal. The method includes receiving an X-bit digital representation of a signal to be filtered and outputting a B-bit digital representation of a filtered output signal. Outputting includes operating an N-bit delay line having an input coupled to the received X-bit digital representation of the signal to be filtered; and addressing a lookup table stored in a storage device with outputs of the delay line. The lookup table represents a mapping between individual ones of the X-bit digital representations of the input signal and a corresponding linearly filtered output signal.

Also disclosed is a mobile station having a wireless communications interface that includes a transceiver. The transceiver includes at least one FIR filter having an input node to receive an X-bit digital representation of a signal to be filtered; an output node to output a B-bit digital representation of a filtered output signal; an N-bit delay line having an input coupled to the input node and N outputs; and a lookup table stored in a storage device having N address inputs coupled to the N outputs of the delay line and B output bits coupled to the output node. The lookup table represents the mapping between individual ones of the X-bit digital representations of the input signal and the corresponding linearly filtered output signal. In non-limiting and exemplary embodiments the X-bit digital representation of the signal to be filtered is generated by a signal modulator that can be comprised, at any given time, of one of an 8-PSK modulator and a 16-QAM modulator.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein: FIG. 1 shows a block diagram of an N-tap 2-Level FIR filter implemented using an N-bit delay line a (2^{N}*B) ROM 14;

FIG. 2A shows an N-tap 4-Level FIR filter as a 4^{N} ROM-based embodiment;

FIG. 2B shows an N-tap 4-Level FIR filter as a 3^{N} ROM-based embodiment;

FIG. 3 illustrates an N-tap 4-Level FIR filter as 4*2-Level FIR filter multiple ROM-based embodiment;

FIG. 4 illustrates an N-tap 2-Level FIR filter segmented ROM embodiment for P segments;

FIG. 5 illustrates a single realization for the constellation points for a 8-PSK modulated signal;

FIG. 6 shows a ROM-based FIR filter embodiment that operates with a modulator, in this non-limiting case an 8-PSK modulator;

FIG. 7 shows a block diagram of a mobile station that includes at least one of the ROM-based FIR filters in accordance with embodiments of this invention; and

FIG. 8 is a logic flow diagram in accordance with embodiments of this invention.

### DETAILED DESCRIPTION OF THE PREFERRED EMBODIMENTS

The presently preferred embodiments of this invention employ a lookup table approach to construct a filtered output signal, as opposed to using the conventional FIR filter structure.

In a first aspect thereof the preferred embodiments of this invention employ a Read Only Memory (ROM), or equivalent, lookup table for signal filtering, where the ROM-based lookup table is developed for binary (2-level) input signals and then expanded for higher-level input signals.

It should be noted that the ROM-based embodiment can be replaced by, as one non-limiting example, a RAM-based embodiment, where for a case where a volatile RAM is employed the lookup table contents can be simply re-written by a local controller each time the RAM is powered on after being powered off. As such, all references herein to a “ROM-based” filter or “ROM filter” or “ROM FIR filter” embodiment should not be construed as being limited to being implemented using a read-only memory type of device per se, but should instead be read in the broader context of a lookup table that is readably stored in some type of addressable memory component, including semiconductor-based memory components and non-semiconductor-based memory components including, but not limited to, rotating disk and other types of memory devices and components.

In a second aspect thereof the preferred embodiments of this invention reduce the ROM size of the first aspect by partitioning the filter into segments.

In a third aspect thereof the preferred embodiments of this invention couple a RF modulator with other ROM-based filter embodiments to further reduce complexity.

It should be pointed out that the first aspect of this invention could be used without the use of the second aspect and/or without the use of the third aspect. Thus, while the presently preferred embodiments of this invention employ all three aspects of this invention, this should not be construed as a necessity or as a limitation upon the practice of this invention.

ROM-Based Filter for Binary and Multi-Level Input Signals

Binary Input ROM Filter

The general form of a FIR filter is expressed as:

$$y ( k ) = {\sum }_{n = 0}^{N - 1} x ( k - n ) w ( n ) , \qquad ( 1 )$$

where x is the input signal to be filtered, y is the filtered output signal and w the FIR filter coefficients. Also, x is a binary antipodal signal x ε{1, −1}. Furthermore, it should be noted that pulse shape filtering involves interpolation for rate conversion to a higher sampling rate of the information stream.

It should be noted that while the presently preferred embodiments of this invention can be generalized to filters that are not used for pulse shape filtering, the concepts of this invention are developed below under that (non-limiting) assumption. In this case, and if one assumes that the interpolation factor is L, then x is constructed from the information sequence, b, to be filtered as:

$$x ( k ) = \{ \begin{matrix}b ( \frac{k}{L} ) , & m = 0 , \pm L , \pm 2 L , … \\ 0 , & otherwise\end{matrix} . \qquad ( 2 )$$

Stated differently, x is formed from the original sequence b, with L−1 zeros inserted between each element of b. Next, if it is assumed that b is a two level antipodal signal then Equation (1) can be written as:

$$\begin{matrix}y ( k ) = {\sum }_{n = 0}^{N - 1} {w}_{x} ( n ) , \\ where & ( 3 ) \\ {w}_{x} ( n ) = \{ \begin{matrix}w ( n ) , & x ( k - n ) = 1 \\ - w ( n ) , & x ( k - n ) = - 1 \\ 0 , & otherwise\end{matrix} . & ( 4 )\end{matrix}$$

Thus, for the case of binary signaling the filtering reduces to the summation or subtraction of the filter taps where the corresponding input value is 1 or −1, respectively. Therefore, the inventors have realized that a lookup table can be created with all possible binary input combinations to address the corresponding filter output in order to implement the filtering operation.

This is shown in FIG. 1, wherein an N-tap 2-Level FIR filter 10 is implemented using an N-bit delay line 12 that receives a one bit input signal (x(k)) and that applies an N-bit address 12A to a (2^{N}*B) ROM 14. The ROM 14 has an output 14A that provides a B-bit representation of y(k).

For illustrative purposes the following filter example is provided:

### EXAMPLE 1

w=[w₀, w₁]
x=[1, −1, −1, 1, 1]
y(1)=w₁−w₀
y(2)=−w₁−w₀
y(3)=−w₁+w₀
y(4)=w₁+w₀

To generate the lookup table 14 one may make the following convenient mapping of x:
1→0 and −1→1 then x=[01100].

If the lookup table 14 is created based on the binary value of the two bits being filtered, it may be accomplished as follows:

$$[ \begin{matrix}0 \\ 1 \\ 2 \\ 3\end{matrix} ] = [ \begin{matrix}{w}_{1} + {w}_{0} \\ {w}_{1} - {w}_{0} \\ - {w}_{1} + {w}_{0} \\ - {w}_{1} - {w}_{0}\end{matrix} ] ,$$

where the address is generated using the two input bits that reside within the two tap filter for that filter output.

In general, the embodiments discussed above would require 2^{N} ROM (or RAM) locations for implementing an FIR filter with binary input values.

It can be noted that the symmetry of the lookup table 14 may be exploited to halve the ROM depth, and by adding an additional 2's complement block to achieve the same result. In the example above it can be seen that table index 3: (−w₁−w₀) actually contains the 2's complement of table index 0: (w₁ w₀). Similarly, table index 2 contains the 2's complement of table index 1. The technique of adding the 2's complement block may be used when the gate count of ROMSIZE/2 is greater then the gate count of the 2's complement block that would replace half of the ROM 14.

It should be noted that the foregoing embodiment of the invention shown in FIG. 1 may provide a simple solution (for reasonable values of N) for the binary case, it quickly becomes less optimum for the case of a multilevel input signal. For example, if one assumes a 2-bit input signal (corresponding to four signal levels) then the ROM 14 (or RAM equivalent) needs to have 4^{N} storage locations. In general, for a k bit input signal, giving M=2^{k} levels, the ROM 14 needs to have to have M^{N} locations. To demonstrate how this quickly this may become impractical the following table is provided:

| K | | | |
|---|---|---|---|
| Input | M | N | ROM 14 |
| bits | Levels | Filter Taps | Locations |
| 1 | 2 | 8 | 64 |
| 1 | 2 | 16 | 65536 |
| 2 | 4 | 8 | 65536 |
| 2 | 4 | 16 | 4.3 × 10⁹ |
| 3 | 8 | 8 | 1.7 × 10⁷ |
| 3 | 8 | 16 | 2.8 × 10¹⁴ |
| 4 | 16 | 8 | 4.3 × 10⁹ |
| 4 | 16 | 16 | 1.8 × 10¹⁹ |

Clearly it quickly becomes more practical to implement the filter 10 using true multipliers and adders for input signals larger than two levels.

Multi-Level Input ROM Filter

The multi-level ROM filter in accordance with embodiments of this invention exploits the general FIR equation given in (1). For the development that follows consider a four level input case, M=4. It will be clear in the ensuing discussion that extensions to higher level input cases are straightforward.

Since a FIR filter is a linear filter that comprises linear combinations of the input and corresponding filter coefficients, it is convenient to rewrite Equation (1) as:

$$y ( k ) = {\sum }_{n = 0}^{N - 1} {x}_{1} ( k - n ) w ( n ) + {\sum }_{n = 0}^{N - 1} {x}_{2} ( k - n ) w ( n ) , \qquad ( 5 )$$

where the following assignments to separate the different amplitudes of the input signal are employed:

$${x}_{1} ( n ) = \{ \begin{matrix}\pm a , & x ( k ) = \pm a \\ 0 , & otherwise\end{matrix} {x}_{2} ( n ) = \{ \begin{matrix}\pm b , & x ( k ) = \pm b \\ 0 , & otherwise\end{matrix} . \qquad ( 6 )$$

To further simplify, Equation (5) can be written as:

$$y ( k ) = a {\sum }_{n = 0}^{N - 1} {x}_{1}^{′} ( k - n ) w ( n ) + b {\sum }_{n = 0}^{N - 1} {x}_{2}^{′} ( k - n ) w ( n ) , \qquad ( 7 )$$

where now the new input sequences are ±1 or 0:

$${x}_{1}^{′} ( n ) = \{ \begin{matrix}\pm 1 , & x ( k ) = \pm a \\ 0 , & otherwise\end{matrix} {x}_{2}^{′} ( n ) = \{ \begin{matrix}\pm 1 , & x ( k ) = \pm b \\ 0 , & otherwise\end{matrix} . \qquad ( 8 )$$

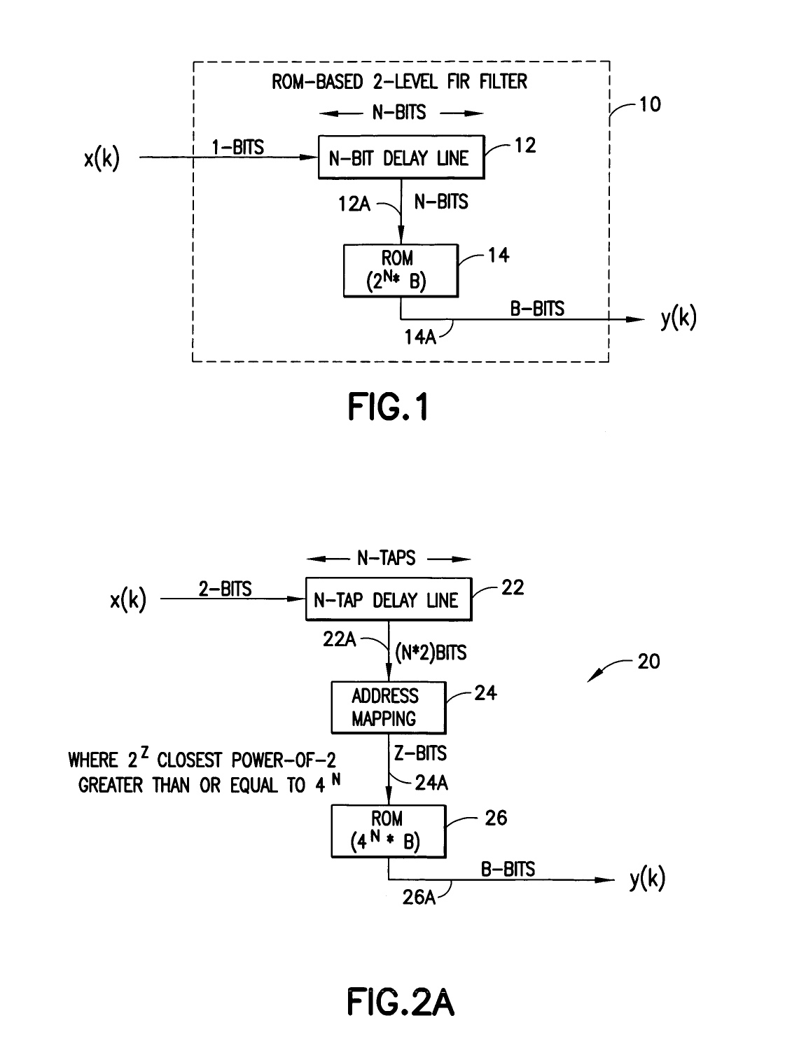

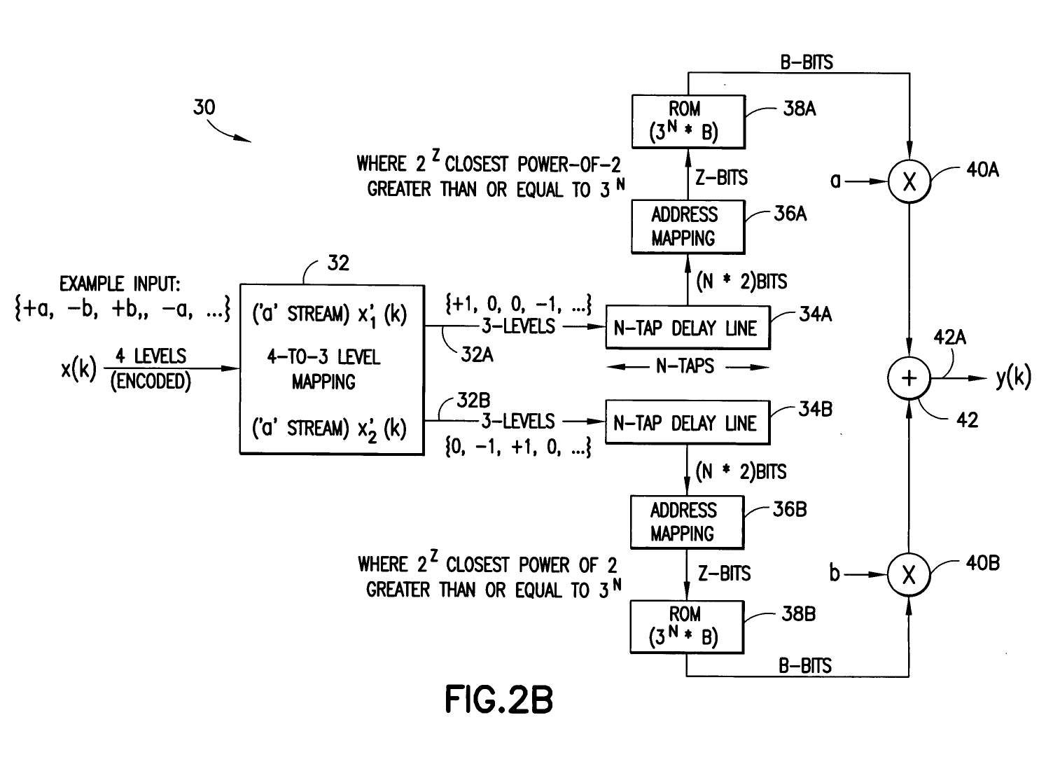

This architecture is illustrated in FIGS. 2A and 2B, where FIG. 2A shows an N-tap 4-Level FIR filter 20 as a 4^{N} ROM-based embodiment, and where FIG. 2B shows an N-tap 4-Level FIR filter 30 as a 3^{N} ROM-based embodiment.

In FIG. 2A the 2-bit input that represents x(k) is applied to an N-tap delay line 22 having an (N*2)bit output 22A that is applied to an address mapping block 24. The address mapping block 24 maps or transforms the (N*2)bit input 22A to a Z-bit output 24A, where 2^{Z} is the closest power of two that is equal to or greater than 4^{N}. The Z-bit output 24A is applied to a (4^{N}*B) ROM 26 storing the lookup table, and that outputs a B-bit representation 26A of the value looked-up in response to the application of the Z-bit input 24A.

FIG. 2B represents an alternative embodiment to the embodiment depicted in FIG. 2A. For the case of the 4-level input, that would have used a 4^{N} ROM table as in FIG. 2A, this embodiment of the invention uses only two, 3^{N} lookup tables 38A, 38B in addition to an adder 42 that is fed by two multipliers 40A, 40B, as well as decision logic to generate the sequences in Equation (8). The value of three arises from the three possible states of +1, −1 and 0 of the sequences in Equation (8). Since the ROM table would be identical for both branches in Equation (7), only one table is required to be used which is then shared amongst the two branches. Thus, for this embodiment only one table of length 3^{N} is required.

In FIG. 2B the encoded 4-level input (e.g., +a, −b, +b, −a, . . . ) is applied to a 4-to-3 level mapping block 32 that outputs a three level a-stream (x′₁(k)) 32A and a three level b-stream (x′₂(k)) 32B having corresponding exemplary mapped values of (+1, 0, 0, −1, . . . ) and (0, −1, +1, 0, . . . ), respectively. The a and b-streams 32A, 32B are applied to associated delay lines 34A, 34B, and thence to address mappers 36A, 36B and ROMs 38A, 38B, each of size (3^{N}*B). ROMs 38A, 38B each output B-bits to respective a and b multipliers 40A, 40B. The outputs of the a and b multipliers 40A, 40B are summed at node 42, thereby producing the y(k) output representation 42A. Note that the b-stream 38B address mapper 36B and ROM 38B may be logic that is shared with the a-stream 32A (or vice versa). The address mapping blocks 36A, 36B each map or transform the (N*2)bit inputs to a Z-bit output, where 2^{Z} is the closest power of two that is equal to or greater than 3^{N}.

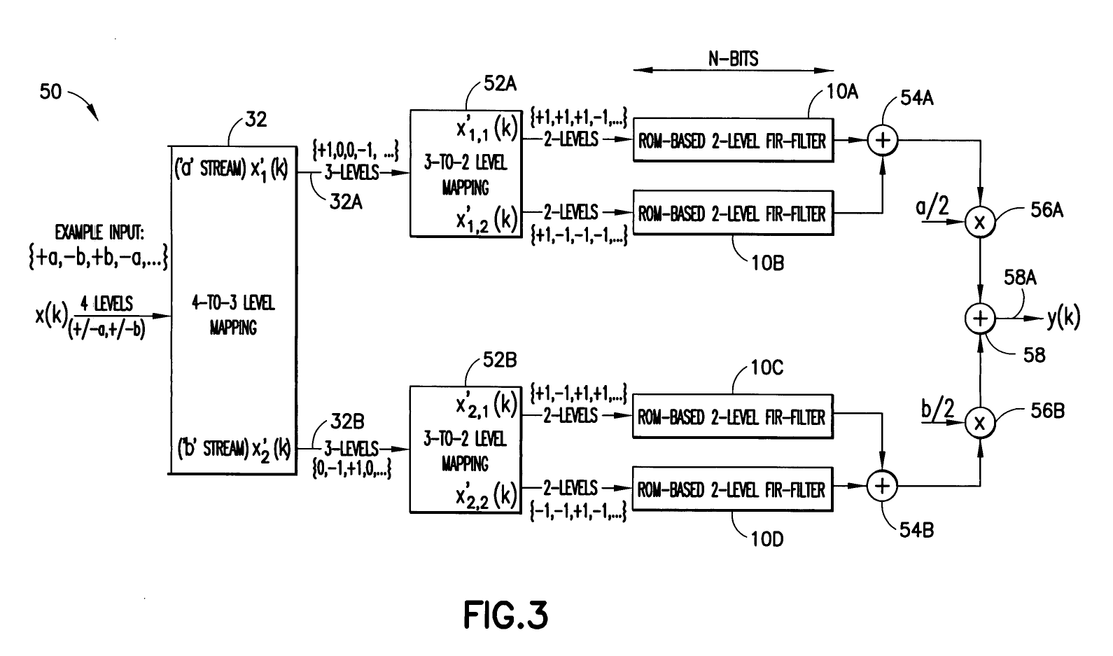

The construction of this embodiment can be further reduced by exploiting the fact that the zero values can be generated using +½, and −½ in two new branches, so that the sum for that weight is zero. This would involve using two additional accesses to the ROM 38 for each branch and scaling the coefficients in Equation (5). This is shown in FIG. 3, and can be expressed as:

$$\begin{matrix}\begin{matrix}y ( k ) = \frac{a}{2} {\sum }_{n = 0}^{N - 1} {x}_{1 , 1}^{′} ( k - n ) w ( n ) + \frac{a}{2} {\sum }_{n = 0}^{N - 1} {x}_{1 , 2}^{′} ( k - n ) w ( n ) + \\ \frac{b}{2} {\sum }_{n = 0}^{N - 1} {x}_{2 , 1}^{′} ( k - n ) w ( n ) + \frac{b}{2} {\sum }_{n = 0}^{N - 1} {x}_{2 , 2}^{′} ( k - n ) w ( n )\end{matrix} \\ where & ( 9 ) \\ {x}_{1 , 1}^{′} ( n ) = \{ \begin{matrix}\pm 1 , & x ( k ) = \pm a \\ 1 , & otherwise\end{matrix} , {x}_{1 , 2}^{′} ( n ) = \{ \begin{matrix}\pm 1 , & x ( k ) = \pm a \\ - 1 , & otherwise\end{matrix} \\ {x}_{2 , 1}^{′} ( n ) = \{ \begin{matrix}\pm 1 , & x ( k ) = \pm b \\ 1 , & otherwise\end{matrix} {x}_{2 , 2}^{′} ( n ) = \{ \begin{matrix}\pm 1 , & x ( k ) = \pm b \\ - 1 , & otherwise\end{matrix} . & ( 10 )\end{matrix}$$

In the N-tap 4-Level FIR filter as 4*2-Level FIR filter embodiment 50 of FIG. 3 the 4-to-3 level mapping block 32 is again used to output the three level a-stream (x′₁(k)) 32A and the three level b-stream (x′₂(k)) 32B, but in this case the streams 32A, 32B are applied to respective 3-2 level mapping blocks 52A, 52B. Note that the exemplary mapped values of (+1, 0, 0, −1, . . . ) and (0, −1, +1, 0, . . . ) from the 4-to-3 level mapping block 32 are further mapped in 3-to-2 level mapping blocks 52A, 52B to x′_{1,1}(k), (x′_{1,2}(k)) and (x′_{2,1}(k)), (x′_{2,2}(k)) two level streams, with exemplary corresponding values of(+1, +1, +1, −1, . . . ), (+1, −1, −1, −1, . . . ) and (+1, −1, +1, −1, . . . ) and (−1, −1, +1, −1, . . . ). The two level streams are applied to four ROM based 2-level FIR filters 10A, 10B, 10C, 10D, each being constructed as shown in FIG. 1. The outputs of the a-stream and b-stream ROM based FIR filters 10A-10D are applied to summing nodes 54A, 54B, which are then applied to a/2 and b/2 multipliers 56A, 56B, followed by summing node 58 that outputs the y(k) output representation.

The lookup tables used for each of the lookup tables in accordance with Equation (7) are identical, and one lookup table can therefore be shared. This would then further reduce the hardware requirement from a 4^{N} ROM lookup table to a single 2^{N} lookup table, with the added requirement of three adders, four multipliers and logic to generate the sequences in Equation (10).

In general, for a M level input signal, this approach uses M/2 ROM accesses, M multipliers, M/2 adders and some additional logic for implementing the control function.

ROM-Based Filter Implementation with Filter Segmentation for Reducing ROM Size.

While the above-described non-limiting embodiments of this invention provide a significant reduction in gate count over true FIR filter implementation for small filter sizes and input bit widths, the gate count and cost can increase rapidly for larger filters. Therefore, in further embodiments of this invention the size of the lookup table, and consequently the size of the ROM or other memory storage device, is reduced over that described above. This is accomplished at least in part by partitioning the filter into multiple, preferably equally sized segments.

Revisiting and rewriting Equation (1), and for simplicity of notation, consider only the binary input case (which can be readily extended to multi-level cases), as:

$$y ( k ) = {\sum }_{n = 0}^{L} x ( k - n ) w ( n ) + {\sum }_{n = L}^{N - 1} x ( k - n ) w ( n ) . \qquad ( 11 )$$

Doing so creates a reduction in the ROM size from 2^{N} into two new ROM tables of 2^{N/2}, with the addition of a single adder. Clearly this can be generalized to the limiting case of:
y(k)=x(k)w(0)+x(k−1)w(1)+ . . . +x(k−N−1)w(N−1), (12)
where now N separate ROM tables of size 2 are used in addition to another N−1 adders. This is easily extended to the multilevel embodiments derived previously.

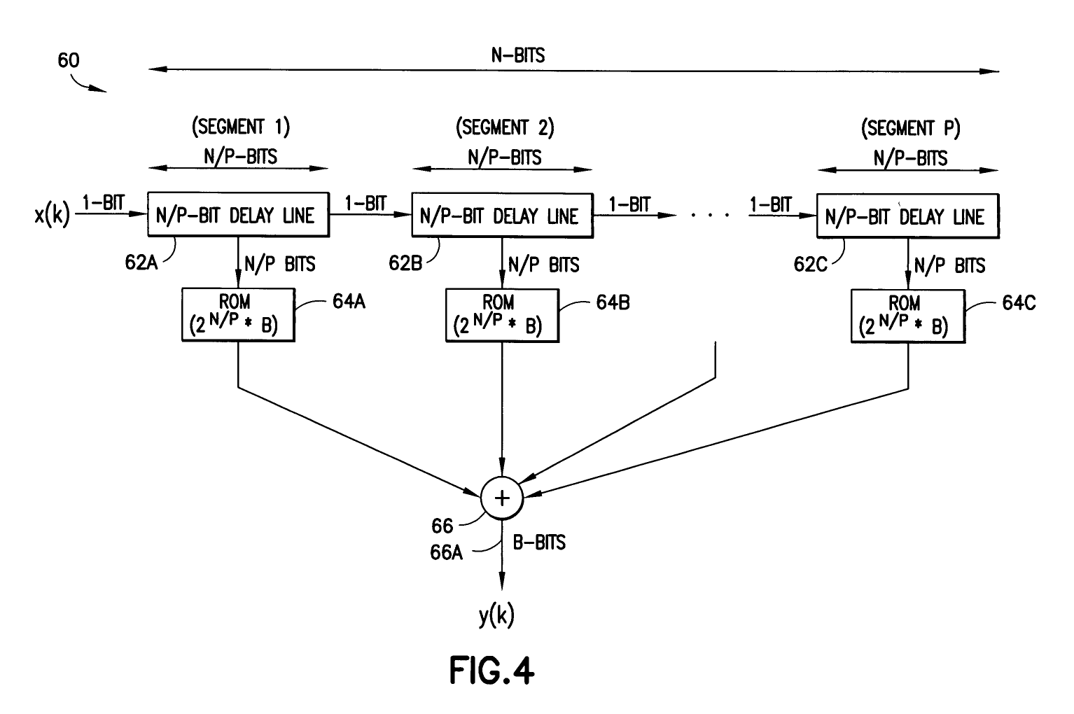

FIG. 4 illustrates an N-tap 2-Level FIR filter segmented ROM embodiment 60 for use with P segments. In this case the N-bit delay line is partitioned into P N/P-bit delay lines 62A, 62B, . . . , 62C, each outputting N/P bits to an associated one of P ROMs 64A, 64B, . . . , 64C each of size 2^{N/P}*B. The ROM outputs are applied to an adder 66 that outputs at 66A the B-bit y(k) representation.

This segmentation flexibility facilitates a minimization problem that can be solved in order to determine the best choice in number of segments, in terms of minimizing the implementation gate count. The expression is provided below where S is the additional cost associated with segmenting the ROM table

$$S = 8 x ( P - 1 ) + \frac{z}{4} {2}^{\frac{N}{P}} + mP . \qquad ( 13 )$$

The first term in Equation (13) accounts for the additional adders (x is the adder input bitwidth), the second term accounts for the ROM size (z is the number of bits each lookup value requires) and the third term accounts for the additional control logic to separate the filter (m is the number of gates/division of the filter for control). Also, P is the number of partition segments. To find the best solution, which minimizes the implementation size S, a derivative is taken of Equation (13) with respect to P and the result is set equal to zero, to give:

$$P ln \{ \frac{4 ( m + 8 x )}{zN ln 2} {p}^{2} \} = N ln 2. \qquad ( 14 )$$

Solving for P provides the number P of segments in order to optimize the design from an implementation complexity perspective. It is interesting to note that but a few stages typically afford most of the gains attained using the optimal number of segments found in (14).

Comparing the conventional FIR filter implementation using true multipliers and adders to the embodiments herein that use ROM-based lookup, it can be shown that the use of this invention can provide a savings of several tens of thousands of gates.

In general, the approach for handling multilevel input signals using the ROM-based embodiments in accordance with this invention can be shown to add an additional 2^{K-1} multipliers and 2^{K/2} −1 adders, in addition to some incremental control logic. From an RF modulator perspective, it can be shown that modulation formats of up to 1024 QAM may benefit from using the ROM-based FIR filter implementations in accordance with the preferred embodiments of this invention. Additionally, the techniques outlined above may readily be extended to modulation formats other than QAM.

Efficient Modulator Mapping for ROM Based Filtering.

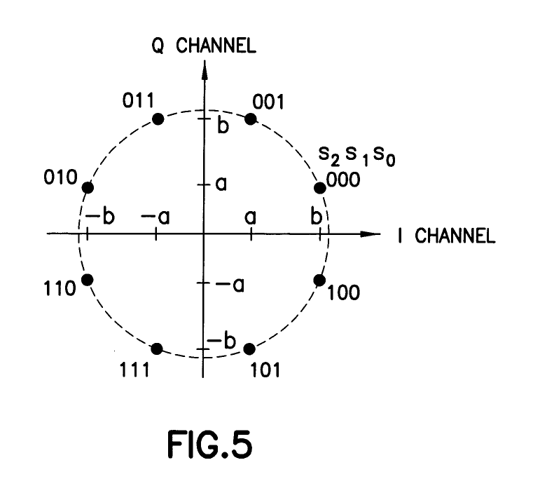

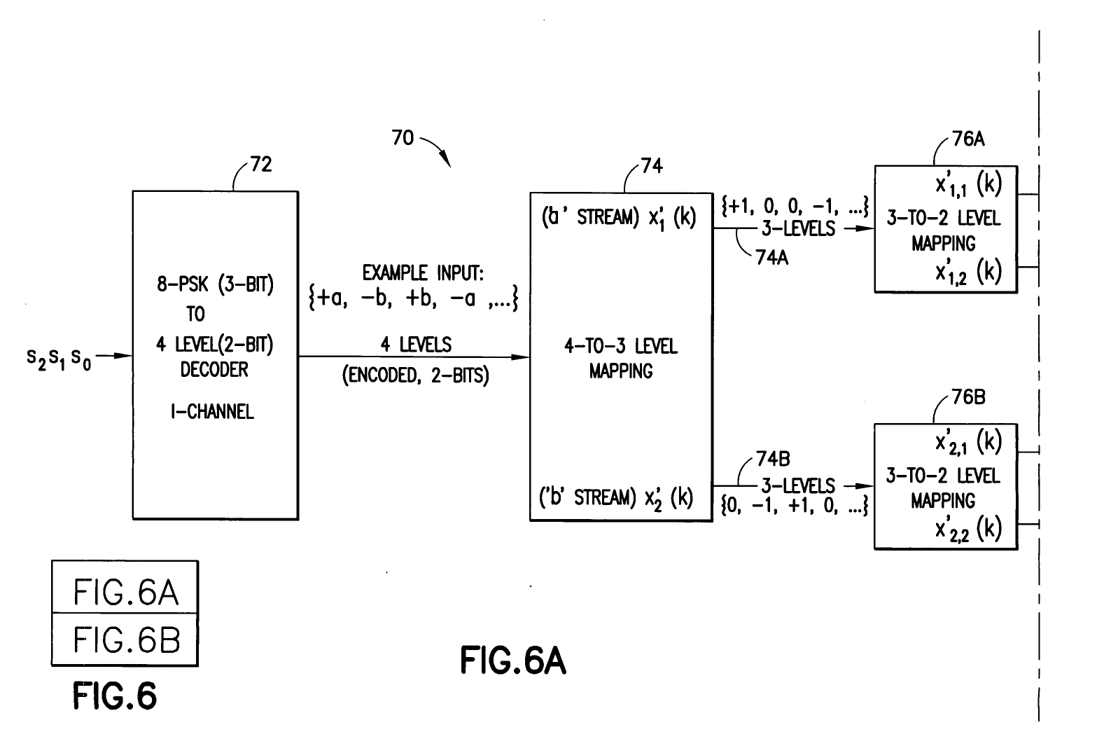

Further in accordance with non-limiting embodiments of this invention, a novel mapping of the modulation function to the ROM-based filter function is now described. This mapping removes the requirement of the comparator logic needed to implement Equation (10). In accordance with this aspect of the invention, the modulator has knowledge of the ROM-based filter and creates a 2-bit word (for the example of Equation (10) which assumes a 4-level input signal) instead of assigning amplitudes, as is done in a conventional modulator. Assume as a non-limiting case an 8-PSK signal, where the constellation points are as shown in FIG. 5, and a ROM-based FIR filter embodiment 70 as shown in FIG. 6. In FIG. 6 a decoder 72 maps 3-bit 8-PSK symbols into a 2-bit value for the In phase Channel (I-Channel) and a 2-bit value for the Quadrature Phase (Q-Channel), where for simplicity only the I-Channel is shown in FIG. 6. The 2-bit values generated by the decoder 72 represent +a, +b, −a and −b. For example, +a, +b, −a and −b can be mapped to 00, 01, 10 and 11, respectively.

For a given I/Q Channel, a 4-to-3 Level Mapping block 74 detects and directs the ‘a’ magnitude symbols (00 and 10 in this example) to the a-stream 74A, re-mapping them as a 2's complement +1 and −1, respectively. A corresponding (arithmetic) zero term is sent to the b-stream 74B. The ‘b’ magnitude symbols (01 and 11 in this example) are sent to the b-stream 74B by the 4-to-3 Level Mapping block 74, which remaps them as a 2's complement +1 and −1, respectively. A corresponding (arithmetic) zero term is sent to the ‘a-stream’ 74A. The a-stream 74A provides an input to a 3-to-2 Level Mapping block 76A, while the b-stream 74B provides an input to a 3-to-2 Level Mapping block 76B. If the a-stream 3-to-2 Level Mapping block 76A detects a +1, it sends a +1 to upper and lower a-stream ROM-based 2-Level FIR filters 10A, 10B. If the a-stream 3-to-2 Level Mapping block 76A detects a −1, it sends a −1 to upper and lower a-stream filters 10A, 10B If the a-stream 3-to-2 Level Mapping block Channel), 76A detects a zero, it sends a +1 to upper a-stream filter 10A, and −1 to the lower a-stream filter 10B. A similar operation occurs for the b-stream 3-to-2 Level Mapping block 76B, which operates with upper and lower b-stream ROM-based 2-Level FIR filters 10C, 10D. The outputs of ROM-based 2-Level FIR filters 10A, 10B are summed at node 78A, multiplied by a/2 in node 80A, and summed with the similarly processed outputs from the ROM-based 2-Level FIR filters 10C, 10D (multiplied by b/2) to form the y(k) representation 82A that is output from summing node 82.

It should be noted that a 16-QAM constellation can also be mapped into a 4-level value for a given I/Q channel. This means that once the initial 16-QAM(4-bit) to 4-level (2-bit) mapping is performed, the same implementation of 4-to-3 and 3-to-2 level mappings and ROM filters can be used to filter 16-QAM signals. That is, 16-QAM and 8-PSK filtering complexity is the same in this non-limiting embodiment of the invention. This further leads to the possibility to programmably change the modulation by simply reprogramming the decoder 72 for each of the I and Q channels.

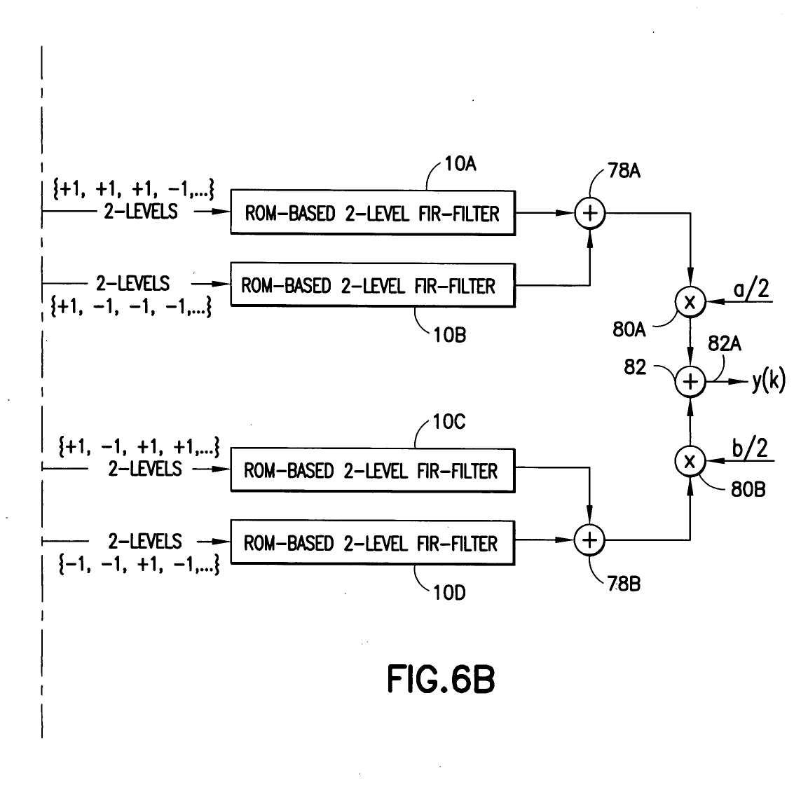

While the linear filter embodiments in accordance with this invention can be used in any of a number of suitable applications, in one presently preferred embodiment, shown in FIG. 7, the ROM-based filter 10 forms a part of a transmitter (TX) 210 of a wireless communications terminal or mobile station 100. It should be noted, however, that the embodiments of this invention apply to many different types of handheld, portable and other types of terminals. For example, the terminals and mobile stations that can benefit from the use of this invention include, but are not limited to, cellular telephones, such as the one depicted in FIG. 7, as well as gaming devices, digital cameras, PDAs, navigation (e.g., GPS) devices, data logging devices, portable bar code scanners, Internet appliances and, in general, any type of electronic equipment that includes at least one signal filter, such as a FIR filter, and that may include a wireless transceiver.

The mobile station 100 typically includes a control unit or control logic, such as a microcontrol unit (MCU) 120 having an output coupled to an input of a display 140 and an input coupled to an output of a keyboard or keypad 160. The MCU 120 is assumed to include or be coupled to some type of a memory, including a non-volatile memory (NVM) 132 for storing an operating program and other information, as well as a volatile memory 130 for temporarily storing required data, scratchpad memory, received packet data, packet data to be transmitted, and the like. The operating program is assumed to enable the MCU 120 to execute the software routines, layers and protocols required to provide a suitable user interface (UI), via display 140 and keypad 160, with a user, as well as to operate the mobile terminal as needed. Although not shown, a microphone and speaker are typically provided for enabling the user to conduct voice calls in a conventional manner.

The mobile station 100 also contains a wireless section that includes a digital signal processor (DSP) 180, or equivalent high speed processor or logic, as well as a wireless transceiver that includes the transmitter 210 and a receiver 220, both of which are coupled to an antenna 240 for communication with a network operator. At least one local oscillator, such as a frequency synthesizer (SYNTH) 260, is provided for tuning the transceiver. Data, such as digitized voice and packet data, is transmitted and received through the antenna 240 in accordance with an air interface standard that may conform to any standard or protocol.

The TX 210 includes at least one of the ROM-based FIR filters 10, and if an I/Q modulator is involved preferably includes a plurality of the ROM-based filters 10, as was described above. The mobile station 100 modulator may also be implemented as shown in FIG. 6.

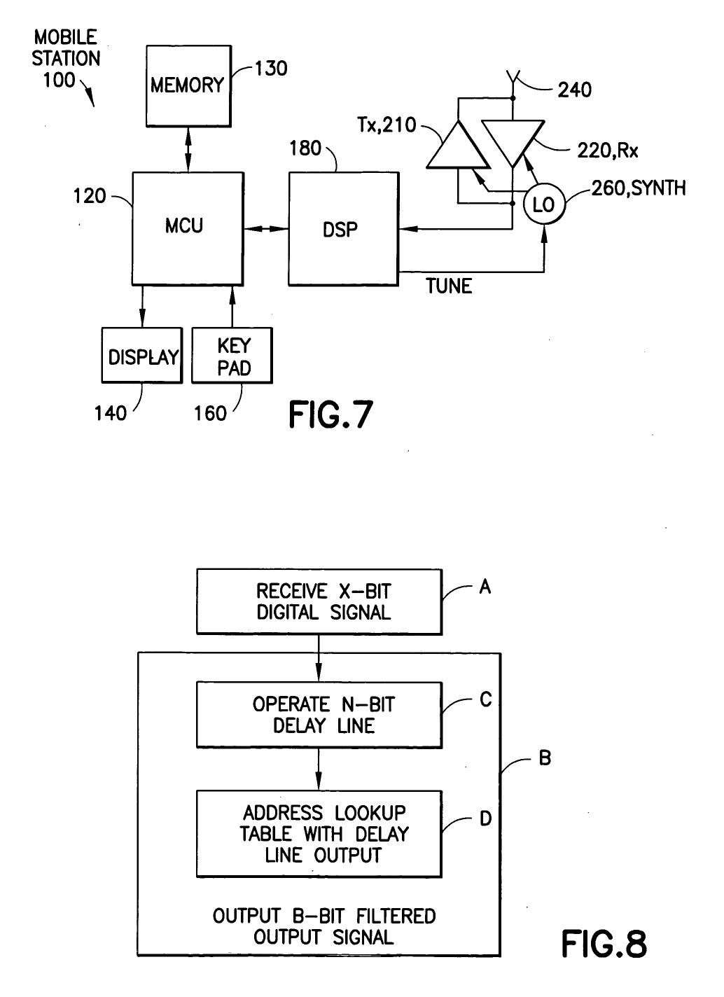

Referring to FIG. 8, a method is also disclosed to filter a signal. The method includes (Block A) receiving an X-bit digital representation of a signal to be filtered and outputting (Block B) a B-bit digital representation of a filtered output signal. Outputting includes (Block C) operating an N-bit delay line having an input coupled to the received X-bit digital representation of the signal to be filtered; and addressing (at Block D)a lookup table stored in a storage device with outputs of the delay line. The lookup table represents a mapping between individual ones of the X-bit digital representations of the input signal and a corresponding linearly filtered output signal.

Based on the foregoing, it cam be appreciated that non-limiting embodiments of this invention provide a hardware efficient TX pulse shape filter when using higher order modulation, which greatly reduces the size and the cost associated with classical pulse shape filters. The non-limiting embodiments of this invention as disclosed above can be used also for other filtering processes, i.e., other than for pulse shape filtering, where the filter input set size is constrained.

Further, the use of the non-limiting embodiments of this invention can reduce the hardware (e.g., ASIC) size and cost, as well as the overall system design development time. Also, the use of the non-limiting embodiments of this invention can provide the ability to produce significantly improved TX signal quality with little cost, whereas with a conventional FIR solution it is costly to attempt to increase the signal quality by a significant amount.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent or different lookup table storage devices, types of filtering applications and modulation types may be attempted by those skilled in the art. However, all such and similar modifications of the teachings of this invention will still fall within the scope of this invention.

Furthermore, some of the features of the presently preferred embodiments of this invention may be used to advantage without the corresponding use of other features. As such, the foregoing description should be considered as merely illustrative of the principles of the various embodiments of this invention, and not in limitation thereof.

What is claimed is:

1. A linear filter, comprising an input node to receive an X-bit digital representation of a signal to be filtered; an output node to output a B-bit digital representation of a filtered output signal; an N-bit delay line having an input coupled to said input node and N outputs; and a lookup table stored in a storage device having N address inputs coupled to said N outputs of said delay line and B output bits coupled to said output node, said lookup table representing a mapping between individual ones of the X-bit digital representations of the input signal and a corresponding linearly filtered output signal.

2. A linear filter as in claim 1, further comprising an address mapped interposed between said delay line and said storage device.

3. A linear filter as in claim 1, further comprising a first input signal mapping function coupled to said input node for performing mapping between a first multi-level input signal representation and a second multi-level input signal representation.

4. A linear filter as in claim 3, where said first multi-level input signal representation is four levels, and where said second multi-level input signal representation is three levels.

5. A linear filter as in claim 4, further comprising a second input signal mapping function having an input coupled to an output of said first input signal mapping function for performing mapping between said second multi-level input signal representation and a third multi-level input signal representation.

6. A linear filter as in claim 5, where said third multi-level input signal representation is two levels.

7. A linear filter as in claim 1, further comprising an input signal mapping function coupled to said input node for performing mapping between a first multi-level input signal representation and a second multi-level input signal representation, said mapping function outputting first and second bit streams, and further comprising first and second lookup tables stored in at least one storage device each coupled to one of said bit streams.

8. A linear filter as in claim 1, further comprising a first input signal mapping function coupled to said input node for performing mapping between a four level input signal representation and a three level input signal representation, said first mapping function outputting first and second bit streams to first and second further input signal mapping functions for performing mapping between the three level input signal representation and a two level input signal representation, each of said first and second further input signal mapping functions outputting first and second bit streams to first and second lookup tables stored in first and second storage devices, further comprising a summation node coupled to an output of each of said first and second storage devices, a multiplication node coupled to an output of the summation node for multiplying the summed output by an amplitude value, and an additional summation node for summing outputs of each of said multiplication nodes.

9. A linear filter as in claim 1, where said N-bit delay line is partitioned into P segments each having N/P bits, each of said P segments being coupled to one of P lookup tables stored in one of P storage devices.

10. A linear filter as in claim 1, where said X-bit digital representation of a signal to be filtered is generated by a signal modulator.

11. A linear filter as in claim 1, where said X-bit digital representation of a signal to be filtered is generated by an 8-PSK modulator.

12. A linear filter as in claim 1, where said X-bit digital representation of a signal to be filtered is generated by a 16-QAM modulator.

13. A method to filter a signal, comprising receiving an X-bit digital representation of a signal to be filtered; and outputting a B-bit digital representation of a filtered output signal; where outputting includes operating an N-bit delay line having an input coupled to said received X-bit digital representation of the signal to be filtered; and addressing a lookup table stored in a storage device with outputs of said delay line, said lookup table representing a mapping between individual ones of the X-bit digital representations of the input signal and a corresponding linearly filtered output signal.

14. A method as in claim 13, further comprising interposing an address mapper between said delay line and said storage device.

15. A method as in claim 13, further comprising coupling a first input signal mapping function to said input node for performing mapping between a first multi-level input signal representation and a second multi-level input signal representation.

16. A method as in claim 15, where said first multi-level input signal representation is four levels, and where said second multi-level input signal representation is three levels.

17. A method as in claim 16, further comprising coupling a second input signal mapping function to an output of said first input signal mapping function for performing mapping between said second multi-level input signal representation and a third multi-level input signal representation.

18. A method as in claim 17, where said third multi-level input signal representation is two levels.

19. A method as in claim 13, further comprising coupling an input signal mapping function to said input node for performing mapping between a first multi-level input signal representation and a second multi-level input signal representation, said mapping function outputting first and second bit streams, and further comprising coupling first and second lookup tables stored in at least one storage device to the first and second bit streams.

20. A method as in claim 13, further comprising coupling a first input signal mapping function to said input node for performing mapping between a four level input signal representation and a three level input signal representation, said first mapping function outputting first and second bit streams to first and second further input signal mapping functions for performing mapping between the three level input signal representation and a two level input signal representation, each of said first and second further input signal mapping functions outputting first and second bit streams to first and second lookup tables stored in first and second storage devices, further comprising coupling a summation node to an output of each of said first and second storage devices, coupling a multiplication node to an output of the summation node for multiplying the summed output by an amplitude value, and coupling an additional summation node for summing outputs of each of said multiplication nodes.

21. A method as in claim 13, further comprising partitioning said N-bit delay line into P segments each having N/P bits, each of said P segments being coupled to one of P lookup tables stored in one of P storage devices.

22. A method as in claim 13, further comprising generating said X-bit digital representation of a signal to be filtered with a signal modulator.

23. A method as in claim 13, further comprising generating said X-bit digital representation of a signal to be filtered with an 8-PSK modulator

24. A method as in claim 13, further comprising generating said X-bit digital representation of a signal to be filtered with a 16-QAM modulator

25. A mobile station comprising a wireless communications interface having a transceiver, said transceiver comprising at least one finite impulse response (FIR) filter, said FIR filter comprising an input node to receive an X-bit digital representation of a signal to be filtered; an output node to output a B-bit digital representation of a filtered output signal; an N-bit delay line having an input coupled to said input node and N outputs; and a lookup table stored in a storage device having N address inputs coupled to said N outputs of said delay line and B output bits coupled to said output node, said lookup table representing a mapping between individual ones of the X-bit digital representations of the input signal and a corresponding linearly filtered output signal.

26. A mobile station as in claim 25, where said X-bit digital representation of a signal to be filtered is generated by a signal modulator.

27. A mobile station as in claim 26, where said signal modulator is comprised, at any given time, of one of an 8-PSK modulator and a 16-QAM modulator.
